(19) United States
(12) Patent Application Publication
(10) Pub. No.: US 2026/0002665 A1
(43) Pub. Date: Jan. 1, 2026

(54) Lamp

(71) Applicant: Shenzhen Oceanwing Smart Innovations Technology Co., Ltd., Shenzhen (CN)

(72) Inventors: Xin Liu, Shenzhen (CN); Junfeng Mao, Shenzhen (CN)

(21) Appl. No.: 19/249,369

(22) Filed: Jun. 25, 2025

(30) Foreign Application Priority Data
Jun. 27, 2024 (CN) 202421506693.7

(51) Int. Cl. F21V 31/00

(52) U.S. Cl. CPC F21V 31/005

(57) ABSTRACT

Disclosed is a lamp including a lamp housing, a lamp component, and an elastic waterproof layer. The lamp housing may comprise an accommodating space and a plurality of penetrating through holes. The lamp component and the elastic waterproof layer may be both disposed in the accommodating space. At least one of an upper structure and/or a side structure of the lamp component may extend out of the lamp housing through a corresponding penetrating through hole. The elastic waterproof layer may be connected to an inner bottom wall of the lamp housing and the lamp component separately to fill a gap between the lamp component and the inner bottom wall of the lamp housing. The elastic waterproof layer may be provided with two mounting through holes along a radial direction of the lamp, and the side structure of the lamp may be configured to pass through the mounting through hole.

### CROSS-REFERENCE TO RELATED APPLICATION

The present application claims priority to Chinese Patent Application No. 202421506693.7, filed on Jun. 27, 2024, which is herein incorporated by reference by its entirety.

### FIELD

The present disclosure relates to the technical field of lighting, in particular to a lamp.

### BACKGROUND

Currently, there are various decorative lamps on the market that can be used in various locations, for example, in outdoor locations. When decorative lamps are used outdoors, such as on charging stations, electric poles, billboards, buildings, and the like, the decorative lamps may be affected by the external environment, meaning that waterproofing can be particularly important. For instance, if external water vapor enters the interior of the lamp, the water vapor may condense on an inner wall of the lamp to form water droplets, affecting the lighting effect or even causing the lamp to fail.

Some manufacturers use a glue filling process to waterproof lamps. However, that glue filling-based approach has problems of poor waterproof performance, high costs, and low production efficiency.

### SUMMARY

The present disclosure provides a lamp with good waterproofing performance at a low cost that can be assembled automatically to improve production efficiency.

Aspects described herein relate to a lamp including a lamp housing, a lamp component, and/or an elastic waterproof layer. The lamp housing may have an accommodating space and a plurality of penetrating through holes communicating with the accommodating space. The lamp component and the elastic waterproof layer may be both disposed in the accommodating space. At least one of an upper structure of the lamp component and a side structure of the lamp component may extend out of the lamp housing through the corresponding penetrating through hole. The elastic waterproof layer may be connected to an inner bottom wall of the lamp housing and the lamp component separately to fill a gap between the lamp component and the inner bottom wall of the lamp housing. The elastic waterproof layer may be provided with two mounting through holes along a radial direction of the lamp. The side structure of the lamp may be configured to pass through the mounting through hole and extend into the corresponding penetrating through hole.

The elastic waterproof layer may comprise a waterproof ring body, the mounting through holes are formed on the waterproof ring body, the lamp component is disposed on a radial inner side of the waterproof ring body, and the elastic waterproof layer is made of a waterproof silicone material.

The waterproof ring body may be provided with a plurality of limiting protrusions, and a plurality of the limiting protrusions may be sequentially arranged along a circumferential direction of the waterproof ring body. The limiting protrusions may be configured to abut against an inner side wall of the lamp housing. The inner bottom wall of the lamp housing may be provided with a plurality of limiting baffles and the limiting baffles may be limiting-connected with the limiting protrusions.

The lamp component may comprise a lens and a lamp panel. The lamp panel may comprise a main body and two support bodies. The two support bodies may be disposed on both sides of the main body. For instance, one end of each of the support bodies may be connected to the main body, and the other end of each of the support bodies may pass through the corresponding mounting through hole. The lens may cover the main body and is stacked on the elastic waterproof layer. The penetrating through holes may comprise a first penetrating through hole extending along an axial direction of the lamp and penetrating the lamp housing. An upper structure of the lens may pass through the first penetrating through hole.

Each of the support bodies may comprise a first straight section, a bent section, and a second straight section. The first straight section may be connected to the main body. The first straight section may pass through the mounting through hole and may be connected to the bent section, and the bent section may be connected to the second straight section. The penetrating through holes may comprise two second penetrating through holes extending along the radial direction of the lamp. The two second penetrating through holes may be symmetrically disposed in the lamp housing, and the second straight section may pass through the corresponding second penetrating through hole.

A radial outer side wall of the lens may be provided with a first locking part, the lamp housing may be provided with a second locking part, and the lens may be locked with the second locking part of the lamp housing via the first locking part.

The lamp housing may comprise a base and a top cover, the base may be provided with a first recess, the top cover may be provided with a second recess, and the first recess and the second recess together may constitute the accommodating space. The top cover may cover the base to seal the accommodating space.

The second penetrating through hole may comprise a first avoidance notch provided in the base, the bent section may be wound around an inner side wall of the base, the first avoidance notch and an outer side wall of the base.

The second penetrating through hole may comprise a second avoidance notch provided in the top cover, and the second straight section may penetrate through the lamp via the second avoidance notch.

A first limiting hook may be provided on a circumferential outer side wall of the base, a second limiting hook may be provided on a radial inner side wall of the top cover, and the first limiting hook and the second limiting hook may be limiting-connected with each other.

A support plate may be provided on a radial outer side wall of the base and may be configured to support part of structure of the second straight section.

The base may be provided with a connecting ear body, and the connecting ear body is provided with a connecting hole.

Aspects described herein provide a number of different advantages. For instance, the lamp provided in the present disclosure may use the elastic waterproof layer to fill the gap between the lens and the base to achieve waterproofing, which may be a simple implementation method and may be easy to implement. Furthermore, the side structure of the lamp panel may pass through the elastic waterproof layer, so that the elastic waterproof layer may be pressed on both sides of the side structure, thereby effectively improving the waterproof performance and preventing liquids such as water vapor from entering. The elastic waterproof layer can be assembled automatically, which improves assembly efficiency and saves labor costs.

### BRIEF DESCRIPTION OF THE DRAWINGS

Accompanying drawings, which are incorporated in and constitute a part of this specification, illustrate examples of the disclosure, which together with the specification serve to explain principles of the disclosure.

In order to more clearly illustrate examples of the disclosure or technical solutions in the related art, the drawings are briefly introduced below. One or more examples are illustrated by the corresponding drawings, which does not constitute a limitation of the examples. Elements with the same reference numerals in the drawings represent similar elements, and the drawings do not constitute a scale limitation unless otherwise specified.

FIG. 1 is an exploded schematic diagram of a lamp;

FIG. 2 is a schematic cross-sectional view of a lamp;

FIG. 3 is a schematic cross-sectional view of a lamp; and

FIG. 4 is a schematic cross-sectional view of a lamp.

### DESCRIPTION OF REFERENCE NUMERALS

1: lamp housing; 11: base; 111: first avoidance notch; 112: first limiting hook; 113: support plate; 1131: silicone pad; 1132: ribbed body; 114: connection hole; 115: connecting ear body; 116: second locking part; 117: limiting baffle; 118: reinforcing annular rib; 12: top cover; 121: second avoidance notch; 122: second limiting hook; 13: accommodating space; 14: penetrating through hole; 141: first penetrating through hole; 142: second penetrating through hole;
2: lamp component; 21: lens; 211: first locking part; 22: lamp panel; 221: main body; 222: support body; 2221: first straight section; 2222: bent section; 2223: second straight section;
3: elastic waterproof layer; 31: waterproof ring body; 32: mounting through hole; 33: limiting protrusion.

### DETAILED DESCRIPTION

In order to make objects, technical solutions, and advantages of examples of the disclosure clearer, the technical solutions in the examples of the disclosure are described in combination with the accompanying drawings in the examples of the present disclosure. The examples described below are not all examples of the disclosure.

Many different examples are disclosed below to illustrate different structures of the disclosure. Aspects described below are only examples and are not intended to limit the disclosure. Furthermore, the present disclosure may repeat reference numerals and/or letters in different examples. The repetition is for simplicity and clarity, and in itself does not indicate the relationship between the various examples and/or arrangements discussed.

For the convenience of description, spatial relationship terms may be used herein to describe the relative positional relationship or movement of one element or feature relative to another element or feature as shown in the drawings, such as “inside,” “outside,” “inner,” “outer,” “under,” “below,” “on,” “above,” “front” and “back.” These spatial relationship terms are intended to include different orientations of the device in use or operation other than orientations depicted in the drawings. For example, if the device in the drawings has a position turnover, a posture change or a movement state change, these directional indications will change accordingly, for example: Elements described as “under or below other elements or features” will be subsequently oriented as “on or over other elements or features.” Thus, the exemplary term “below” may include both orientations of above and below. The device may be otherwise oriented (rotated by 90 degrees or in other directions), and the spatial relationship description used herein are interpreted accordingly.

Aspects described herein relate to a lamp which uses the elastic waterproof layer to fill the gap between the lens and the base to achieve waterproofing, which is a simple implementation method that is easy to implement and that can be produced affordably. One advantage of this approach is that, because the side structure of the lamp panel passes through the elastic waterproof layer, the elastic waterproof layer is pressed on both sides of the side structure, thereby effectively improving the waterproof performance and preventing liquids such as water vapor from entering. The elastic waterproof layer may additionally and/or alternatively be assembled automatically, which improves assembly efficiency and saves labor costs.

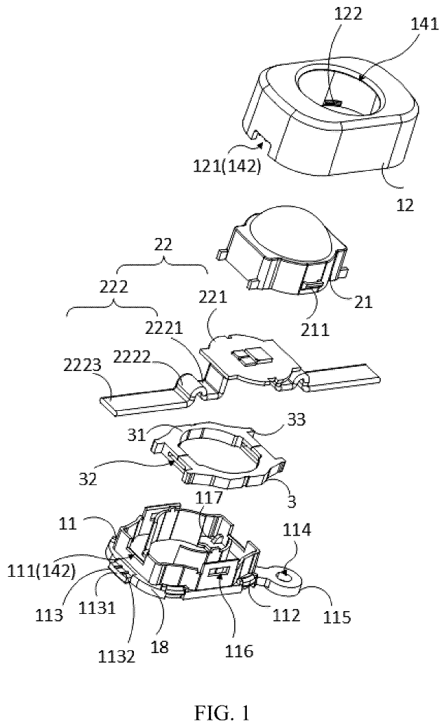

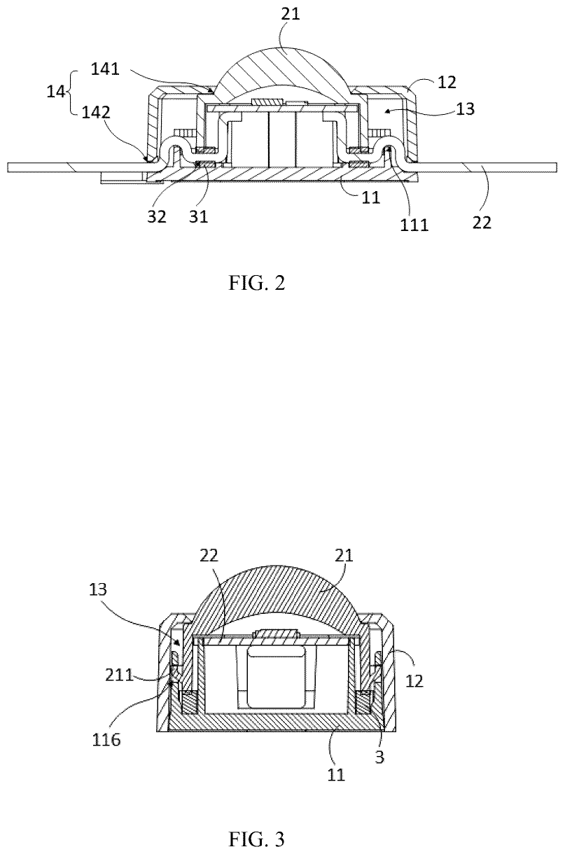

In some exemplary examples, as shown in FIGS. 1 to 4, a lamp can be applied to charging stations, electric poles, billboards, buildings and the like to meet lighting needs. The lamp includes a lamp housing 1, a lamp component 2 and an elastic waterproof layer 3.

The lamp housing 1 may comprise an accommodating space 13 and a plurality of penetrating through holes 14 communicating with the accommodating space 13. The lamp component 2 and the elastic waterproof layer 3 may be both disposed in the accommodating space 13. Part of structure of the lamp component 2 may extend out of the lamp housing 1 through a plurality of the penetrating through holes 14.

The penetrating through holes 14 may include, for example, a first penetrating through hole 141 extending along an axial direction of the lamp and penetrating the lamp housing 1, so that an upper structure of the lamp component 2 may extend out of the lamp housing 1 to the outside through the first penetrating through hole 141 to expose the upper structure of the lamp component 2. Accordingly, when the lamp is energized, a light beam may be emitted to the outside through the upper structure of the lamp component 2 to achieve lighting.

The penetrating through holes 14 may include, for example, two second penetrating through holes 142 extending along a radial direction of the lamp, and the two second penetrating through holes 142 may be symmetrically disposed on both sides of the lamp housing 1. A side structure of the lamp component 2 may extend out of the lamp housing 1 to the outside through the corresponding second penetrating through hole 142, so as to establish an electrical connection with an external power supply device to meet the lighting needs of the lamp.

The elastic waterproof layer 3 may be connected to each of an inner bottom wall of the lamp housing 1 and the lamp component 2 to fill a gap between the lamp component 2 and the inner bottom wall of the lamp housing 1, which may, for example, meet the waterproof requirements of the lamp, prevent liquids such as water vapor from entering the lamp, and effectively extend the service life of the lamp. The elastic waterproof layer 3 may be made of a waterproof silicone material.

The elastic waterproof layer 3 may be provided with two mounting through holes 32 along the radial direction of the lamp. The side structure of the lamp component 2 may be configured to pass through the corresponding mounting though hole 32 and may extend into the corresponding second penetrating through holes 142, and may further pass through the second penetrating through holes 142 to extend to the outside of the lamp housing 1. The elastic waterproof layer 3 may have a certain level of elasticity and can be compressed. Therefore, when the side structure of the lamp component 2 passes through the mounting through hole 32, the mounting through hole 32 may clamp the side structure of the lamp component 2 to, for example, prevent water vapor and other liquids from entering an interior of the lamp.

As shown in FIG. 1, the elastic waterproof layer 3 may include a waterproof ring body 31. The mounting through holes 32 may be formed in the waterproof ring body 31 and may penetrate the waterproof ring body 31 in the radial direction of the lamp. This may permit the lamp component 2 to smoothly pass through the mounting through holes 32. The lamp component 2 may be arranged on a radial inner side of the waterproof ring body 31 and may be surrounded by the waterproof ring body 31, which may achieve waterproofing in a circumferential direction of the lamp component 2 and improving the waterproof performance.

The waterproof ring body 31 may be provided with a plurality of limiting protrusions 33, and the plurality of limiting protrusions 33 may be sequentially arranged along a circumferential direction of the waterproof ring body 31. For example, four limiting protrusions 33 may be provided, which may be respectively arranged at four corner ends of the waterproof ring body 31 to balance the stability of limiting. The limiting protrusion 33 is only for illustrative purposes and does not constitute a limitation to the present disclosure, aspects described herein may be configured with any number of limiting protrusions (or no limiting protrusions at all).

The limiting protrusion 33 may be configured to abut against an inner wall of the lamp housing 1, and the limiting protrusion 33 and the inner wall of the lamp housing 1 may abut against each other to achieve limiting. This configuration may ensure the stability of the elastic waterproof layer 3 when mounted.

The limiting protrusion 33 may be limit-connected with the lamp housing 1. A plurality of limiting baffles 117 may be arranged on the inner bottom wall of the lamp housing 1, and a gap may be formed between each limiting baffle 117 and the inner side wall of the lamp housing 1, and the limiting protrusion 33 may be inserted into the gap to achieve the limiting mounting of the elastic waterproof layer 3. A width of the gap may be made the same as the size of the limiting protrusion 33, so that the limiting protrusion 33 may achieve a clamped state, which may effectively prevent the elastic waterproof layer 3 from shaking or deflecting.

As shown in FIGS. 1 to 4, the lamp component 2 may include a lens 21 and a lamp panel 22. On the lamp panel 22, a circuit board, a light source, wires, and the like may be integrated to support normal lighting of the lamp panel 22.

The lamp panel 22 may include a main body 221 and two support bodies 222. The two support bodies 222 may be arranged on both sides of the main body 221. One end of each support body 222 may be connected to the main body 221. The two support bodies 222 may correspond to the two mounting through holes 32 one by one, so that the other end of each support body 222 passes through the corresponding mounting through hole 32.

Each of the support bodies 222 may include a first straight section 2221, a bent section 2222, and a second straight section 2223. One end of the first straight section 2221 may be connected to the main body 221, and the other end of the first straight section 2221 may pass through the mounting though hole 32 and may be connected to one end of the bent section 2222. The other end of the bent section 2222 may be connected to one end of the second straight section 2223, and the other end of the second straight section 2223 may pass through the corresponding second penetrating through hole 142. The bent section 2222 may be, for example, an inverted U-shaped structure, increasing the bending path of the lamp panel 22, and may forms an obstacle with the lamp housing 1. This configuration may effectively prevent the lamp panel 22 from falling out of the lamp housing 1 due to an external dragging force, and may improve the stability of the lamp panel 22 when mounted.

The lens 21 may cover the main body 221 and may be stacked on the elastic waterproof layer 3 to fill a gap between the lens 21 and the inner bottom wall of the lamp housing 1 to achieve waterproofing. A radial outer side wall of the lens 21 may be provided with a first locking part 211, the lamp housing 1 may be provided with a second locking part 116, and the lens 21 may be locked with the second locking part 116 of the lamp housing 1 via the first locking part 211.

The first locking part 211 may be, for example, a protruding structure, and the second locking part 116 may be, for example, a locking groove, and the protruding structure may be inserted into the locking groove. The locking groove may penetrate the side wall of the lamp housing 1, and/or may be provided in the lamp housing 1 in the form of a blind hole (e.g., as long as the protruding structure can be inserted into the locking groove).

The first locking part 211 need not be limited to one locking part: for example, two first locking parts may be provided. The two first locking parts 211 may be symmetrically disposed along the radial direction of the lamp, which may improve the stability of mounting. The number of the first locking parts 211 may also be three, and the number of the second locking parts 116 may be the same as that of the first locking parts 211, so that the first locking parts lock to the second locking parts correspondingly.

As shown in FIGS. 1 to 4, the lamp housing 1 may include a base 11 and a top cover 12. The base 11 may be provided with a first recess, and the top cover 12 is provided with a second recess. The first recess and the second recess together may constitute the accommodating space 13. The top cover 12 may cover the base 11 to seal the first recess and the second recess, protect the structure in the accommodating space 13, and improve safety during use. The top cover 12 may surround the base 11 to ensure the flatness of the appearance.

The second penetrating through hole 142 may include at least a first avoidance notch 111 provided in the base 11. The bent section 2222 may be wound around an inner side wall of the base 11, the first avoidance notch 111 and the outer side wall of the base 11, so that the bent section 2222 may fit the side wall of the base 11. Further, the bent section 2222 may cooperate with the side wall of the base 11, further ensuring the reliability of the lamp panel 22 when mounted. This configuration may prevent the lamp panel from being dragged out of the accommodating space 13 and affecting the normal lighting of the lamp. The number of the first avoidance notches 111 may be two, so as to correspond one to one with the bent sections 2222.

The second penetrating through hole 142 may include a second avoidance notch 121 provided in the top cover 12, and the second avoidance notch 121 may be provided close to a lower edge of the top cover 12 to avoid despairing the integrity of the top cover 12. The second straight section 2223 may penetrate through the lamp via the second avoidance notch 121 so as to be electrically connected to an external device.

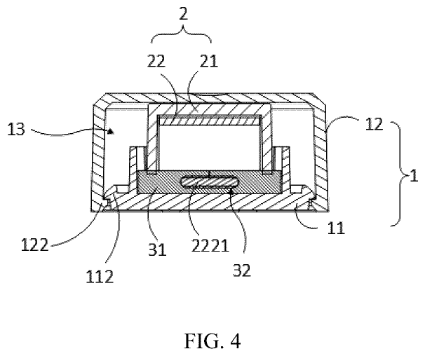

As shown in FIGS. 1 and 4, a first limiting hook 112 may be provided on a circumferential outer side wall of the base 11, and a second limiting hook 122 may be provided on a radial inner side wall of the top cover 12. The first limiting hook 112 and the second limiting hook 122 may be hooked with each other to achieve a limiting connection, thereby improving the reliability of the connection between the base 11 and the top cover 12.

A plurality of first limiting hooks 112 may be provided that are evenly distributed along a circumferential direction of the base 11, and the number of the second limiting hooks 122 may coincide with the number of the first limiting hooks 112.

In this example, as shown in FIG. 1, a support plate 113 may be further provided on a radial outer side wall of the base 11, and the support plate 113 may be configured to support part of the structure of the second straight section 2223 to prevent damage to the second straight section 2223 when the top cover 12 is pressed against the second straight section. A silicone pad 1131 may be provided on the support plate 113 to provide support and protection for the second straight section 2223. A ribbed body 1132 may be provided on the silicone pad 1131 to increase the friction with the second straight section 2223 and prevent the second straight section 2223 from being deflected or misaligned.

The circumferential outer side wall of the base 11 may also be provided with a reinforcing annular rib 118, which may be arranged between the support plate 113 and the first limiting hook 112 and between two adjacent first limiting hooks 112. This configuration may improve the overall strength of the support plate 113 and the first limiting hooks 112.

As shown in FIG. 1, the base 11 may be provided with a connecting ear body 115, and the connecting ear body 115 may be provided with a connecting hole 114. The connecting hole 114 may be, for example, a threaded hole, through which a fastener such as a screw or a bolt can be passed to fix the lamp at a target position, thereby fixing the lamp and meeting the needs of users.

The lamp proposed in the present disclosure may use the elastic waterproof layer to fill the gap between the lens and the base to achieve waterproofing, which may be a simple implementation method and is easy to implement. Furthermore, the side structure of the lamp panel may pass through the elastic waterproof layer, so that the elastic waterproof layer may be pressed on both sides of the first straight section, thereby effectively improving the waterproof performance and preventing entry of liquids such as water vapor. The elastic waterproof layer may be made of a waterproof silicone material, which may give the elastic waterproof layer a certain level of elasticity and allows the elastic waterproof layer to be compressed. Compared with conventional glue filling processes, the elastic waterproof layer may have a better waterproof performance, and the elastic state can also properly protect the lamp and improve its safety. At the same time, the elastic waterproof layer may be assembled automatically, which may improve assembly efficiency and saves labor costs.

It should be understood that the terms used herein are only for the purpose of describing specific exemplary examples and are not intended to be limiting. Unless the context clearly indicates otherwise, the singular forms “a,” “an” and “the” as used herein can also mean including plural forms. The terms “include,” “contain,” “comprise” and “have” are inclusive and thus indicate the presence of features, steps, operations, elements and/or components described, but do not exclude the presence or addition of one or more other features, steps, operations, elements, components, and/or combinations thereof. The method steps, procedures, and operations described herein are not interpreted as necessarily requiring them to be executed in the specific order described, unless the execution order is explicitly indicated. It should also be understood that additional or alternative steps may be used.

Although a plurality of elements, components, regions, layers and/or sections can be described herein with the terms first, second, third, and the like, they should not be limited by these terms. These terms may be only used to distinguish one element, component, region, layer or section from another ones. Terms such as “first” and “second” and other numerical terms do not imply sequence or order when used herein unless clearly indicated in the context. Accordingly, the first element, component, region, layer or section discussed below may be referred to as a second element, component, region, layer or section without departing from teachings of the exemplary examples.

The foregoing description is only the description of examples of the disclosure to enable a person skilled in the art to understand or implement the disclosure. Various modifications to these examples will be apparent to a person skilled in the art, and general principles defined herein may be implemented in other examples without departing from the spirit or scope of the disclosure. Thus, the disclosure is not limited to the examples shown herein.

What is claimed is:

1. A lamp comprising:
a lamp housing,
a lamp component, and
an elastic waterproof layer, wherein:
the lamp housing has an accommodating space and a plurality of penetrating through holes communicating with the accommodating space, the lamp component and the elastic waterproof layer are both disposed in the accommodating space, at least one of an upper structure of the lamp component and a side structure of the lamp component extends out of the lamp housing through the corresponding penetrating through hole;
the elastic waterproof layer is connected to an inner bottom wall of the lamp housing and the lamp component separately to fill a gap between the lamp component and the inner bottom wall of the lamp housing; and
the elastic waterproof layer is provided with two mounting through holes along a radial direction of the lamp, and the side structure of the lamp is configured to pass through a mounting through hole and extend into the corresponding penetrating through hole.

2. The lamp according to claim 1, wherein:
the elastic waterproof layer comprises a waterproof ring body,
the mounting through holes are formed on the waterproof ring body,
the lamp component is disposed on a radial inner side of the waterproof ring body, and
the elastic waterproof layer is made of a waterproof silicone material.

3. The lamp according to claim 2, wherein:
the waterproof ring body is provided with a plurality of limiting protrusions,
a plurality of the limiting protrusions are sequentially arranged along a circumferential direction of the waterproof ring body, and
one or both of:
the limiting protrusions are configured to abut against an inner side wall of the lamp housing; or
the inner bottom wall of the lamp housing is provided with a plurality of limiting baffles and the limiting baffles are limiting-connected with the limiting protrusions.

4. The lamp according to claim 2, wherein:
the lamp component comprises a lens and a lamp panel;
the lamp panel comprises a main body and two support bodies, the two support bodies are disposed on both sides of the main body, one end of each of the support bodies is connected to the main body, and the other end of each of the support bodies passes through the corresponding mounting through hole; and
the lens covers the main body and is stacked on the elastic waterproof layer, the penetrating through holes comprise a first penetrating through hole extending along an axial direction of the lamp and penetrating the lamp housing, and an upper structure of the lens passes through the first penetrating through hole.

5. The lamp according to claim 4, wherein:
each of the support bodies comprises:
a first straight section,
a bent section, and
a second straight section,
the first straight section is connected to the main body, the first straight section passes through the mounting through hole and is connected to the bent section, and the bent section is connected to the second straight section; and
the penetrating through holes comprise two second penetrating through holes extending along the radial direction of the lamp, the two second penetrating through holes are symmetrically disposed in the lamp housing, and the second straight section passes through the corresponding second penetrating through hole.

6. The lamp according to claim 4, wherein:
a radial outer side wall of the lens is provided with a first locking part,
the lamp housing is provided with a second locking part, and
the lens is locked with the second locking part of the lamp housing via the first locking part.

7. The lamp according to claim 5, wherein:
the lamp housing comprises a base and a top cover,
the base is provided with a first recess,
the top cover is provided with a second recess,
the first recess and the second recess together constitute the accommodating space, and
the top cover covers the base to seal the accommodating space.

8. The lamp according to claim 7, wherein:
the second penetrating through hole at least comprises a first avoidance notch provided in the base, and
the bent section is wound around an inner side wall of the base, the first avoidance notch, and an outer side wall of the base.

9. The lamp according to claim 7, wherein:
the second penetrating through hole at least comprises a second avoidance notch provided in the top cover, and
the second straight section penetrates through the lamp via the second avoidance notch.

10. The lamp according to claim 7, wherein:
a first limiting hook is provided on a circumferential outer side wall of the base,
a second limiting hook is provided on a radial inner side wall of the top cover, and
the first limiting hook and the second limiting hook are limiting-connected with each other.

11. The lamp according to claim 7, wherein a support plate is provided on a radial outer side wall of the base and is configured to support part of structure of the second straight section.

12. The lamp according to claim 7, wherein:
the base is provided with a connecting ear body, and
the connecting ear body is provided with a connecting hole.

13. A lamp comprising:
a lamp housing comprising:
an accommodating space, wherein the accommodating space comprises:
a lamp component; and
an elastic waterproof layer connected to an inner bottom wall of the lamp housing and the lamp component separately to fill a gap between the lamp component and the inner bottom wall of the lamp housing; and
a plurality of penetrating through holes communicating with the accommodating space, wherein a side structure of the lamp is configured to pass through a mounting through hole of the elastic waterproof layer and extend into a corresponding penetrating through hole of the plurality of penetrating through holes.

14. The lamp of claim 13, wherein at least one of an upper structure of the lamp component and the side structure of the lamp component extends out of the lamp housing through the corresponding penetrating through hole.

15. The lamp of claim 13, wherein the elastic waterproof layer is provided with two mounting through holes along a radial direction of the lamp.

16. The lamp of claim 13, wherein:
the elastic waterproof layer comprises a waterproof ring body,
the mounting through hole is formed on the waterproof ring body, and
the lamp component is disposed on a radial inner side of the waterproof ring body.

17. The lamp of claim 13, wherein:
the elastic waterproof layer is made of a waterproof silicone material.

18. The lamp of claim 13, wherein the lamp component comprises a lens stacked on the elastic waterproof layer.

19. The lamp of claim 13, wherein:
the elastic waterproof layer comprises a waterproof ring body comprising a plurality of limiting protrusions sequentially arranged along a circumferential direction of the waterproof ring body.

20. The lamp of claim 19, wherein the limiting protrusions are configured to abut against an inner side wall of the lamp housing.
